(19) United States
(12) Patent Application Publication
(10) Pub. No.: US 2023/0266991 A1
(43) Pub. Date: Aug. 24, 2023

(54) REAL-TIME ESTIMATION FOR MIGRATION TRANSFERS

(71) Applicant: VMWARE, INC., Palo Alto, CA (US)

(72) Inventors: VIPUL PATEL, Bangalore (IN); BHAVESH SHARMA, Bangalore (IN); SUMIT KUMAR, Bangalore (IN); VEMANA MURTY, Bangalore (IN)

(21) Appl. No.: 17/728,997

(22) Filed: Apr. 26, 2022

(30) Foreign Application Priority Data
Feb. 23, 2022 (IN) 202241009599

(51) Int. Cl. G06F 9/455

(52) U.S. Cl. CPC G06F 9/45558; G06F 2009/4557; G06F 2009/45595

(57) ABSTRACT

System and computer-implemented method for migrating virtual computing instances from source computer networks to target computer networks uses a delta sum of a plurality of the data transfer metrics collected, during a current time window, from at least one of a source computer network and a target computer network during a replication process of copying data of a virtual computing instance from the source computer network to the target computer network. The delta sum is used to derive a current data transfer rate, which is used to compute a first estimation of transfer completion time using a moving average rate, and to compute a second estimation of transfer completion time using a weighted moving average rate with weights defined by an alpha value. The alpha value is selectively adjusted for a subsequent estimation of transfer completion time using divergence of the first and second estimations of transfer completion time.

### RELATED APPLICATION

Benefit is claimed under 35 U.S.C. 119(a)-(d) to Foreign Application Serial No. 202241009599 filed in India entitled “REAL-TIME ESTIMATION FOR MIGRATION TRANSFERS”, on Feb. 23, 2022, by VMware, Inc., which is herein incorporated in its entirety by reference for all purposes.

### BACKGROUND

Cloud architectures are used in cloud computing and cloud storage systems for offering infrastructure-as-a-service (IaaS) cloud services. Examples of cloud architectures include the VMware Cloud architecture software, Amazon EC2™ web service, and OpenStack™ open source cloud computing service. IaaS cloud service is a type of cloud service that provides access to physical and/or virtual resources in a cloud environment. These services provide a tenant application programming interface (API) that supports operations for manipulating IaaS constructs, such as virtual computing instances (VCIs), e.g., virtual machines (VMs), and logical networks.

A cloud system may aggregate the resources from both private and public clouds. A private cloud can include one or more customer data centers (referred to herein as “on-premise data centers”). A public cloud can include a multi-tenant cloud architecture providing IaaS cloud services. In a cloud system, it is desirable to support VCI migration between different private clouds, between different public clouds and between a private cloud and a public cloud for various reasons, such as workload management.

In a conventional VM migration process of interest, migrating a VM at a source cloud to a target cloud involves a replication phase and a cutover phase. The replication phase includes transferring a copy of VM data from the source cloud to the target cloud. Only after the replication phase has been completed, the cutover phase can be performed to bring up the VM at the target cloud. Hence, estimating the completion time for the replication phase is key to determining schedule for the cutover phase. However, the estimating the completion time for the replication phase is challenging since the performance of the replication phase is influenced by many system parameters at both the source and target clouds of migration.

### SUMMARY

System and computer-implemented method for migrating virtual computing instances from source computer networks to target computer networks uses a delta sum of a plurality of the data transfer metrics collected, during a current time window, from at least one of a source computer network and a target computer network during a replication process of copying data of a virtual computing instance from the source computer network to the target computer network. The delta sum is used to derive a current data transfer rate, which is used to compute a first estimation of transfer completion time using a moving average rate, and to compute a second estimation of transfer completion time using a weighted moving average rate with weights defined by an alpha value. The alpha value is selectively adjusted for a subsequent estimation of transfer completion time using divergence of the first and second estimations of transfer completion time.

A computer-implemented method for migrating virtual computing instances from source computer networks to target computer networks in accordance with an embodiment of the invention comprises collecting data transfer metrics from at least one of a source computer network and a target computer network during a replication process of copying data of a virtual computing instance from the source computer network to the target computer network, computing a delta sum of a plurality of the data transfer metrics collected during a current time window, deriving a current data transfer rate using the delta sum and a duration of the current time window, computing a first estimation of transfer completion time using a moving average rate of the current data transfer rate and a previous data transfer rate, and remaining data of the virtual computing instance to be transmitted from the source computer network to the target computer network, computing a second estimation of transfer completion time using a weighted moving average rate of the current data transfer rate and the previous data transfer rate with weights defined by an alpha value, and the remaining data, and selectively adjusting the alpha value for a subsequent estimation of transfer completion time using divergence of the first and second estimations of transfer completion time. In some embodiments, the steps of this method are performed when program instructions contained in a computer-readable storage medium are executed by one or more processors.

A system in accordance with an embodiment of the invention comprises memory and one or more processors configured to collect data transfer metrics from at least one of a source computer network and a target computer network during a replication process of copying data of a virtual computing instance from the source computer network to the target computer network, compute a delta sum of a plurality of the data transfer metrics collected during a current time window, derive a current data transfer rate using the delta sum and a duration of the current time window, compute a first estimation of transfer completion time using a moving average rate of the current data transfer rate and a previous data transfer rate, and remaining data of the virtual computing instance to be transmitted from the source computer network to the target computer network, compute a second estimation of transfer completion time using a weighted moving average rate of the current data transfer rate and the previous data transfer rate with weights defined by an alpha value, and the remaining data, and selectively adjust the alpha value for a subsequent estimation of transfer completion time using divergence of the first and second estimations of transfer completion time.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a cloud system in accordance with an embodiment of the invention.

FIG. 2 shows components of a migration system in the cloud system depicted in FIG. 1 in accordance with an embodiment of the invention.

FIG. 3 is a process flow diagram of the migration process executed by the migration system in accordance with an embodiment of the invention.

FIG. 4 is a bar graph of “data transferred” snapshot values over time T1-T10 in accordance with an embodiment of the invention.

FIG. 5 is a graph of “data transfer rate” over time, which illustrates different behaviors, in accordance with an embodiment of the invention.

FIG. 6 is a bar graph of “data transferred” snapshot values over time T1-T10, which illustrates the calculation of a weighted MA data transfer rate in accordance with an embodiment of the invention.

FIG. 7 shows graphs of three “estimated time to complete” values (estimations) computed without using moving average, using moving average and using weighted moving average in accordance with an embodiment of the invention.

FIG. 8 shows the graphs of three “estimated time to complete” values (estimations) shown in FIG. 7 and a graph of estimations using weighted moving average with feedback in accordance with an embodiment of the invention.

FIGS. 9A and 9B show a flow diagram of the process of computing a data transfer completion estimation for a VM by each estimator in an estimation sub-system of the migration system shown in FIG. 2 in accordance with an embodiment of the invention.

FIG. 10 is a process flow diagram of a computer-implemented method for migrating virtual computing instances from source computer networks to target computer networks in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

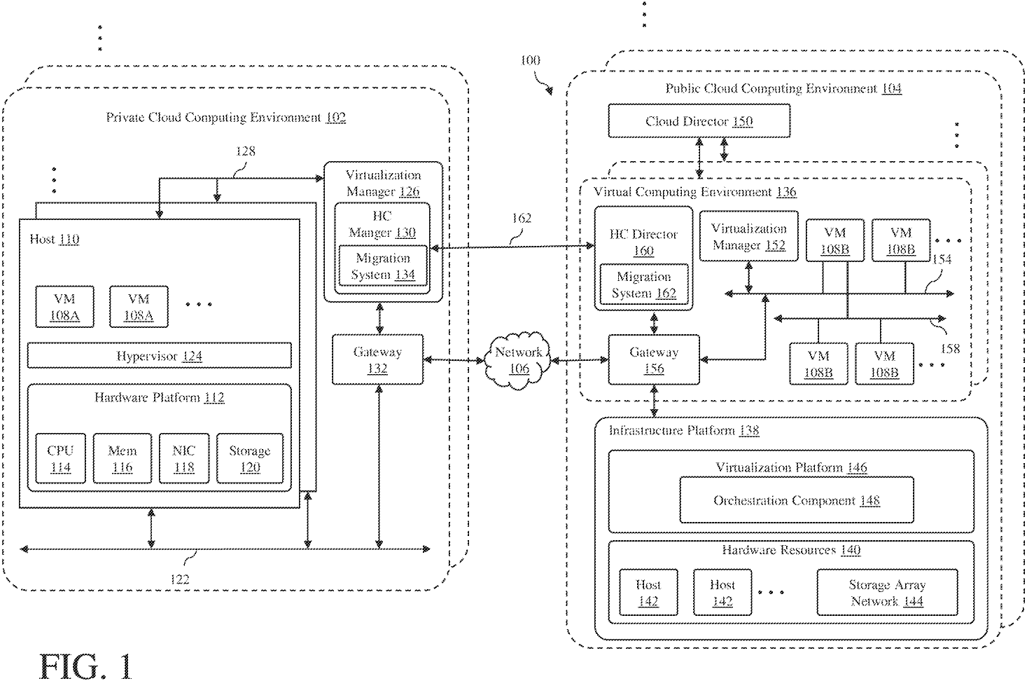

Turning now to FIG. 1, a block diagram of a cloud system 100 in which embodiments of the invention may be implemented in accordance with an embodiment of the invention is shown. The cloud system 100 includes one or more private cloud computing environments 102 and/or one or more public cloud computing environments 104 that are connected via a network 106. The cloud system 100 is configured to provide a common platform for managing and executing workloads seamlessly between the private and public cloud computing environments. In one embodiment, one or more private cloud computing environments 102 may be controlled and administrated by a particular enterprise or business organization, while one or more public cloud computing environments 104 may be operated by a cloud computing service provider and exposed as a service available to account holders, such as the particular enterprise in addition to other enterprises. In some embodiments, each private cloud computing environment 102 may be a private or on-premise data center.

The private and public cloud computing environments 102 and 104 of the cloud system 100 include computing and/or storage infrastructures to support a number of virtual computing instances 108A and 108B. As used herein, the term “virtual computing instance” refers to any software processing entity that can run on a computer system, such as a software application, a software process, a virtual machine (VM), e.g., a VM supported by virtualization products of VMware, Inc., and a software “container”, e.g., a Docker container. However, in this disclosure, the virtual computing instances will be described as being virtual machines, although embodiments of the invention described herein are not limited to virtual machines.

As explained below, the cloud system 100 supports migration of the virtual machines 108A and 108B between any of the private and public cloud computing environments 102 and 104. The cloud system 100 may also support migration of the virtual machines 108A and 108B between different sites situated at different physical locations, which may be situated in different private and/or public cloud computing environments 102 and 104 or, in some cases, the same computing environment.

As shown in FIG. 1, each private cloud computing environment 102 of the cloud system 100 includes one or more host computer systems (“hosts”) 110. The hosts may be constructed on a server grade hardware platform 112, such as an x86 architecture platform. As shown, the hardware platform of each host may include conventional components of a computing device, such as one or more processors (e.g., CPUs) 114, system memory 116, a network interface 118, storage system 120, and other I/O devices such as, for example, a mouse and a keyboard (not shown). The processor 114 is configured to execute instructions, for example, executable instructions that perform one or more operations described herein and may be stored in the memory 116 and the storage system 120. The memory 116 is volatile memory used for retrieving programs and processing data. The memory 116 may include, for example, one or more random access memory (RAM) modules. The network interface 118 enables the host 110 to communicate with another device via a communication medium, such as a network 122 within the private cloud computing environment. The network interface 118 may be one or more network adapters, also referred to as a Network Interface Card (NIC). The storage system 120 represents local storage devices (e.g., one or more hard disks, flash memory modules, solid state disks and optical disks) and/or a storage interface that enables the host to communicate with one or more network data storage systems. Example of a storage interface is a host bus adapter (HBA) that couples the host to one or more storage arrays, such as a storage area network (SAN) or a network-attached storage (NAS), as well as other network data storage systems. The storage system 120 is used to store information, such as executable instructions, cryptographic keys, virtual disks, configurations and other data, which can be retrieved by the host.

Each host 110 may be configured to provide a virtualization layer that abstracts processor, memory, storage and networking resources of the hardware platform 112 into the virtual computing instances, e.g., the virtual machines 108A, that run concurrently on the same host. The virtual machines run on top of a software interface layer, which is referred to herein as a hypervisor 124, that enables sharing of the hardware resources of the host by the virtual machines. One example of the hypervisor 124 that may be used in an embodiment described herein is a VMware ESXi™ hypervisor provided as part of the VMware vSphere® solution made commercially available from VMware, Inc. The hypervisor 124 may run on top of the operating system of the host or directly on hardware components of the host. For other types of virtual computing instances, the host may include other virtualization software platforms to support those virtual computing instances, such as Docker virtualization platform to support software containers.

Each private cloud computing environment 102 includes a virtualization manager 126 that communicates with the hosts 110 via a management network 128. In an embodiment, the virtualization manager 126 is a computer program that resides and executes in a computer system, such as one of the hosts 110, or in a virtual computing instance, such as one of the virtual machines 108A running on the hosts. One example of the virtualization manager 126 is the VMware vCenter Server® product made available from VMware, Inc. The virtualization manager 126 is configured to carry out administrative tasks for the private cloud computing environment 102, including managing the hosts, managing the virtual machines running within each host, provisioning virtual machines, deploying virtual machines, migrating virtual machines from one host to another host, and load balancing between the hosts.

In one embodiment, the virtualization manager 126 includes a hybrid cloud (HC) manager 130 configured to manage and integrate computing resources provided by the private cloud computing environment 102 with computing resources provided by one or more of the public cloud computing environments 104 to form a unified “hybrid” computing platform. The hybrid cloud manager is responsible for migrating/transferring virtual machines between the private cloud computing environment and one or more of the public cloud computing environments, and perform other “cross-cloud” administrative tasks. In one implementation, the hybrid cloud manager 130 is a module or plug-in to the virtualization manager 126, although other implementations may be used, such as a separate computer program executing in any computer system or running in a virtual machine in one of the hosts. One example of the hybrid cloud manager 130 is the VMware® HCX™ product made available from VMware, Inc.

In the illustrated embodiment, the HC manager 130 further includes a migration engine 134, which performs operations related to migrating virtual machines between the private cloud computing environment 102 to other computer networks, such as the public cloud computing environment 104 or another private cloud computing environment. Although the migration engine 134 is shown to reside in the hybrid cloud manager 130, the migration engine may reside anywhere in the private cloud computing environment 102 or in another computer network in other embodiments. The migration engine 134 and its operations will be described in detail below.

In one embodiment, the hybrid cloud manager 130 is configured to control network traffic into the network 106 via a gateway device 132, which may be implemented as a virtual appliance. The gateway device 132 is configured to provide the virtual machines 108A and other devices in the private cloud computing environment 102 with connectivity to external devices via the network 106. The gateway device 132 may manage external public Internet Protocol (IP) addresses for the virtual machines 108A and route traffic incoming to and outgoing from the private cloud computing environment and provide networking services, such as firewalls, network address translation (NAT), dynamic host configuration protocol (DHCP), load balancing, and virtual private network (VPN) connectivity over the network 106.

Each public cloud computing environment 104 of the cloud system 100 is configured to dynamically provide an enterprise (or users of an enterprise) with one or more virtual computing environments 136 in which an administrator of the enterprise may provision virtual computing instances, e.g., the virtual machines 108B, and install and execute various applications in the virtual computing instances. Each public cloud computing environment includes an infrastructure platform 138 upon which the virtual computing environments can be executed. In the particular embodiment of FIG. 1, the infrastructure platform 138 includes hardware resources 140 having computing resources (e.g., hosts 142), storage resources (e.g., one or more storage array systems, such as a storage area network (SAN) 144), and networking resources (not illustrated), and a virtualization platform 146, which is programmed and/or configured to provide the virtual computing environments 136 that support the virtual machines 108B across the hosts 142. The virtualization platform may be implemented using one or more software programs that reside and execute in one or more computer systems, such as the hosts 142, or in one or more virtual computing instances, such as the virtual machines 108B, running on the hosts.

In one embodiment, the virtualization platform 146 includes an orchestration component 148 that provides infrastructure resources to the virtual computing environments 136 responsive to provisioning requests. The orchestration component may instantiate virtual machines according to a requested template that defines one or more virtual machines having specified virtual computing resources (e.g., compute, networking and storage resources). Further, the orchestration component may monitor the infrastructure resource consumption levels and requirements of the virtual computing environments and provide additional infrastructure resources to the virtual computing environments as needed or desired. In one example, similar to the private cloud computing environments 102, the virtualization platform may be implemented by running on the hosts 142 VMware ESXi™-based hypervisor technologies provided by VMware, Inc. However, the virtualization platform may be implemented using any other virtualization technologies, including Xen®, Microsoft Hyper-V® and/or Docker virtualization technologies, depending on the virtual computing instances being used in the public cloud computing environment 104.

In one embodiment, each public cloud computing environment 104 may include a cloud director 150 that manages allocation of virtual computing resources to an enterprise. The cloud director may be accessible to users via a REST (Representational State Transfer) API (Application Programming Interface) or any other client-server communication protocol. The cloud director may authenticate connection attempts from the enterprise using credentials issued by the cloud computing provider. The cloud director receives provisioning requests submitted (e.g., via REST API calls) and may propagate such requests to the orchestration component 148 to instantiate the requested virtual machines (e.g., the virtual machines 108B). One example of the cloud director is the VMware vCloud Director® product from VMware, Inc. The public cloud computing environment 104 may be VMware cloud (VMC) on Amazon Web Services (AWS).

In one embodiment, at least some of the virtual computing environments 136 may be configured as virtual data centers. Each virtual computing environment includes one or more virtual computing instances, such as the virtual machines 108B, and one or more virtualization managers 152. The virtualization managers 152 may be similar to the virtualization manager 126 in the private cloud computing environments 102. One example of the virtualization manager 152 is the VMware vCenter Server® product made available from VMware, Inc. Each virtual computing environment may further include one or more virtual networks 154 used to communicate between the virtual machines 108B running in that environment and managed by at least one networking gateway device 156, as well as one or more isolated internal networks 158 not connected to the gateway device 156. The gateway device 156, which may be a virtual appliance, is configured to provide the virtual machines 108B and other components in the virtual computing environment 136 with connectivity to external devices, such as components in the private cloud computing environments 102 via the network 106. The gateway device 156 operates in a similar manner as the gateway device 132 in the private cloud computing environments.

In one embodiment, each virtual computing environments 136 includes a hybrid cloud (HC) director 160 configured to communicate with the corresponding hybrid cloud manager 130 in at least one of the private cloud computing environments 102 to enable a common virtualized computing platform between the private and public cloud computing environments. The hybrid cloud director may communicate with the hybrid cloud manager using Internet-based traffic via a VPN tunnel established between the gateways 132 and 156, or alternatively, using a direct connection 162.

As shown in FIG. 1, the hybrid cloud director 160 includes a migration system 164, which may be a cloud version of an migration engine similar to the migration system 134. The migration system 164 in the virtual computing environment 136 and the migration system 134 in the private cloud computing environment 102 facilitate cross-cloud migration of virtual computing instances, such as virtual machines 108A and 108B, between the private and public computing environments. This cross-cloud migration may include “cold migration”, which refers to migrating a VM which is always powered off throughout the migration process, “hot migration”, which refers to live migration of a VM where the VM is always in powered on state without any disruption, and “bulk migration, which is a combination where a VM remains powered on during the replication phase but is briefly powered off, and then eventually turned on at the end of the cutover phase. The migration systems in different computer networks, such as the private cloud computing environment 102 and the virtual computing environment 136, operate to enable migrations between any computing environments, such as between private cloud computing environments, between public cloud computing environments, between a private cloud computing environment and a public cloud computing environment, between virtual computing environments in one or more public cloud computing environments, between a virtual computing environment in a public cloud computing environment and a private cloud computing environment, etc. As used herein, “computer network” includes any computing environment, including a data center. As an example, the hybrid cloud director 160 may be a component of the HCX-Cloud product and the hybrid cloud manager 130 may be a component of the HCX-Enterprise product, which are provided by VMware, Inc.

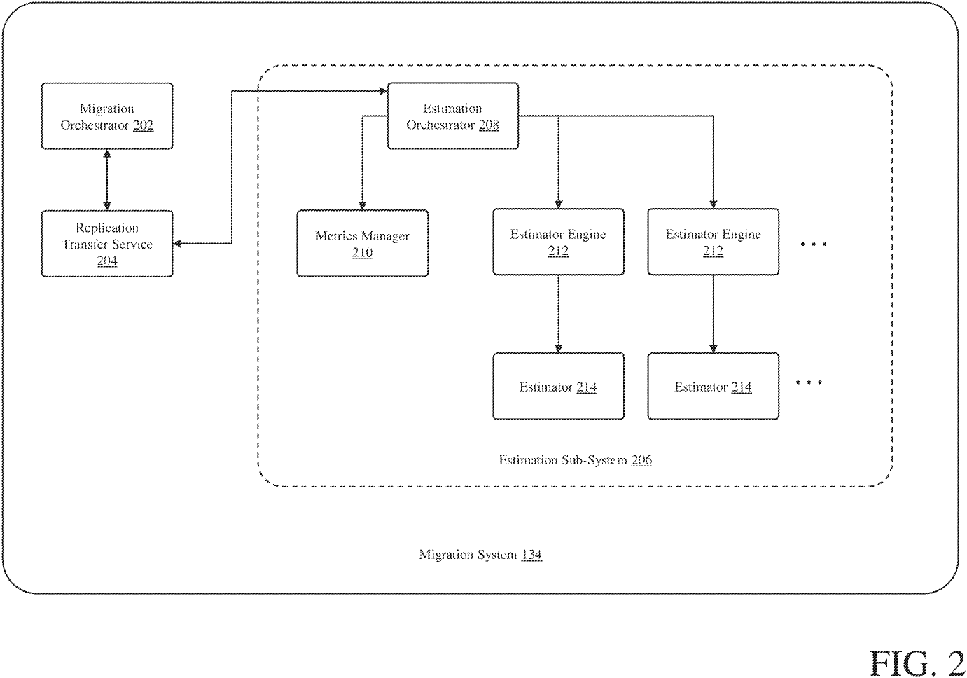

Turning now to FIG. 2, components of the migration system 134 in the hybrid cloud manager 130 of the private cloud computing environment 102 in accordance with an embodiment of the invention are shown. The migration system 164 in the hybrid cloud director 160 of the virtual computing environment 136 or in other computer networks may include similar components. In VM migration from a source computer network to a target computer network, the migration systems in the source and target computer networks cooperatively operate migrate one or more VMs using one or more replication technology, such as vSphere replication, which may depend on the workload on the VMs and the characteristics of the network bridging the source and target computer networks.

The VM migrations may be performed in a bulk and planned manner in a way so as not to affect the business continuity. In an embodiment, the migration is performed in two phases, a replication phase (initial copy of each VM being migrated) and then a cutover phase. The replication phase involves copying and transferring the entire VM data from the source computer network to the target computer network. The replication phase may also involve periodically transferring delta data (new data) from the VM, which continues to run during the replication phase, to the target computer network. The cutover phase may involve powering off the original source VM at the source computer network, flushing leftover virtual disk of the source VM to the target compute network, and then creating and powering on a new VM at the target computer network. The cutover phase may cause brief downtime of services hosted on the migrated VM. Hence, it is extremely critical to plan this cutover phase in a way that business continuity is minimally affected. The precursor to the cutover phase being successful is a completion of the initial copy, i.e., the replication phase. Thus, it is very much essential to have an insight into the overall transfer time of the replication phase so that administrators can schedule the cutover window accordingly. The migration systems in accordance with embodiments of the invention provide a real-time estimation of the duration of the replication phase while it is underway to aid administrators in configuring the cutover window, considering the ever-changing environment dynamics.

As shown in FIG. 2, the migration system 134 includes a migration orchestrator 202, a replication transfer service 204 and an estimation sub-system 206. The migration system 134 may include additional components, which assist in VM migrations, such as those found in the VMware® HCX™ products, when install and running in a system.

The migration orchestrator 202 operates to oversee, manage and monitor entire migration processes between the private cloud computing environment 102 and other computer networks, such as the virtual computing environment 136. As part of its operation, the migration orchestrator 202 communicates with the replication transfer service 204, which instructs the estimation sub-system 206 to start and stop the process of providing estimations of replication completion time as replication transfer is being executed.

As shown in FIG. 2, the estimation sub-system 206 includes an estimation orchestrator 208, a metrics manager 210 and a number of pairs of estimator engine 212 and estimator 214 (sometimes referred to herein as “estimator pairs”). The estimation orchestrator 208 operates to manage the estimation process. In an embodiment, the estimator orchestrator 208 instructs the metrics manager 208 to initiate collection of metrics that are used to calculate estimations by each of the estimator pairs, which handles estimations for a portion of the VMs being migrated. The estimator orchestrator 208 also instructs each of the estimator engines 212 to start and stop the estimation calculation process.

The estimator engine 212 in each of the estimation pair operates fetch active transfers, and look up each estimator job to check whether estimation should be performed for that active transfer. The estimator engine 212 also instructs the associated estimator 214 to execute one or more estimator jobs to provide estimations of replication completion time. The estimator 214 in each of the estimation pair operates to execute the estimator jobs from the corresponding estimator engine 212 to generate estimations of replication completion time for one or more VMs being migrated. The process of calculating an estimation by each of the estimators 214 is described in detail below. Each estimator 214 then provides the longest duration estimation as its output estimation to the migration orchestrator 202 or another component in the hybrid manager 130, which presents the longest duration estimation among the output estimations from the different estimators 214 as the final estimation. The final estimation may be presented to administrators via a graphic user interface (GUI).

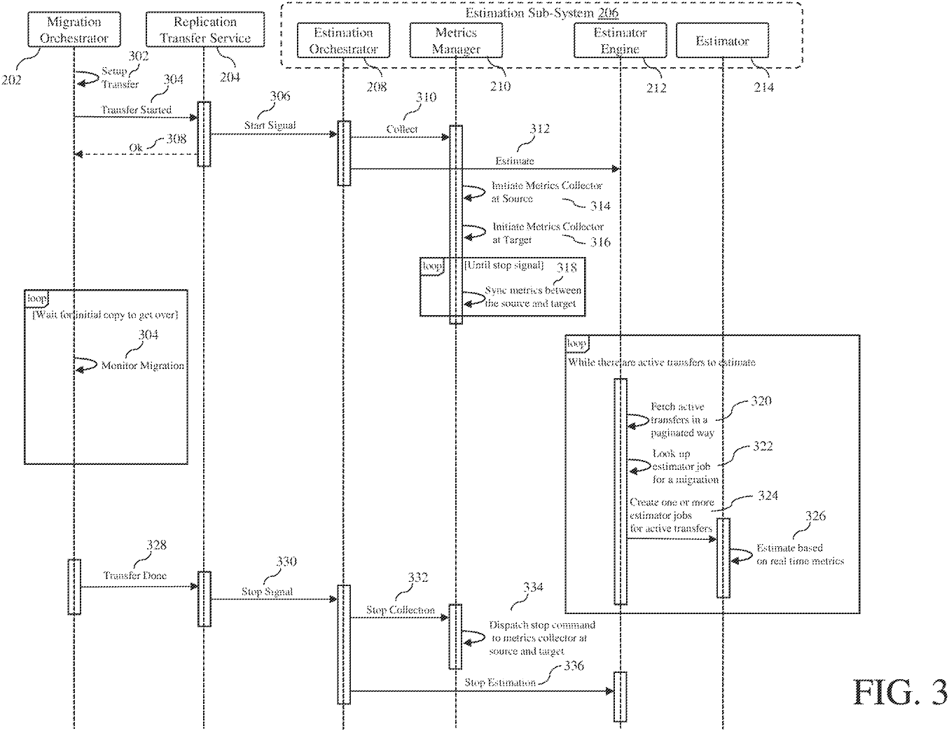

The migration process executed by the migration system 134 with respect to generating estimations of replication completion time in accordance with an embodiment of the invention is described with reference to a process flow diagram of FIG. 3. The migration operation begins with the migration orchestrator 202 in response to a request from an administrator to migrate one or more VMs from the private cloud computing environment 102 and another computer network, such as the virtual computing environment 136.

At step 302, the migration or transfer is initiated by the migration orchestrator 202 in response to the migration request. This initiation step may involve executing various operations to prepare for VM migration. Next, at step 304, a notification is sent from the migration orchestrator 202 to the replication transfer service 204 to indicate that a transfer has started.

Next, at step 306, in response to the notification of the transfer being started, a start signal is transmitted from the replication transfer service 204 to the estimation orchestrator 208. Next, at optional step 308, a response signal is transmitted from the replication transfer service 204 back to the migration orchestrator 202 that the notification was received and the estimation process has been properly initiated.

Next, at step 310, in response to the start signal, an instruction to collect data transfer metrics is transmitted from the estimation orchestrator 208 to the metrics manager 210. The data transfer metrics for each VM being migrated may include (1) bytesToTransfer (remaining bytes to be transferred), (2) bytesTransferred, (bytes actually transferred so far), (3) checksumComparedBytes (blocks of bytes for which checksum process has already been run, and (4) checksumTotalBytes (total bytes which are to be checksummed including the blocks of bytes that have been checksummed). Next, at step 312, in response to the start signal, an instruction to initiate an estimation calculation process is transmitted from the estimation orchestrator 208 to each of the estimator engines 212.

Next, at step 314, in response to the instruction to collect data transfer metrics, a metrics collector at the source computer network is initiated by the metrics manager 210. In addition, at step 316, in response to the instruction to collect data transfer metrics, a metrics collector at the target computer network is also initiated by the metrics manager 210. The metric collector may be initiated anywhere in the source and target computer networks, such as the virtual manager 126 or another module.

Next, at step 318, collected metrics from the source and target computer networks are synchronized by the metrics manager 210 in a loop until a stop signal is received.

Next, steps 320-326 are executed by the estimator engine 212 and the estimator 214 in a loop while there are active transfers (i.e., active replications) to estimate. Active transfers refer to migrations that are in the replication phase of the migration process. At step 320, the active transfers are fetched in a paginated way by the estimator engine 214. Fetching active transfers in a paginated way means that the active transfers are retried in a batch and each batch is delegated to one instance of estimator job. The reason for this approach is to not overwhelm the migration system with a large number of transfer phase details when a large number of migrations are being performed concurrently.

Next, at step 322, each estimator job for a migration is looked up by the estimator engine 214. In an embodiment, every migration type (including bulk migration) being performed by the hybrid manager 130 rides on top of migration orchestration platform (also known as “mobility platform”). Although different technologies to enable migration may be available, the estimation algorithm may not be implemented for each migration type. Hence, this step ensures that the estimation algorithm has been implemented for each migration type. Thus, the migration type is checked against metadata of migration types for which estimation process should be triggered. The estimation algorithm is not initiated for any migration type not found in the metadata of migration types, which may be stored in any storage accessible by the migration system 134.

Next, at step 324, an instruction is transmitted from the estimator engine 212 to the estimator 214 to create one or more estimator jobs for active transfers. In this embodiment, each estimator job can handle estimation for more than one VM transfer.

Next, at step 326, in response to the instruction from the estimator engine 212, corresponding estimator jobs are created by the estimator 214. For each estimator job, an estimation of replication completion time is computed by the estimator 214. The process of computing each estimation of replication completion time is described in detail below.

At step 328, when the transfer has completed, a notification is transmitted from the migration orchestrator 202 to the replication transfer service 204 to indicate that the transfer has ended. Next, at step 330, in response to the notification of the transfer being ended, a stop signal is transmitted from the replication transfer service 204 to the estimation orchestrator 208. Next, at step 332, in response to the stop signal, an instruction to stop collecting data transfer metrics is transmitted from the estimation orchestrator 208 to the metrics manager 210, which causes the metrics manager to dispatch a stop commands to the metric collectors at the source and target computer networks, at step 334. In addition, at step 336, in response to the stop signal, an instruction to stop the estimation process is transmitted from the estimation orchestrator 208 to each of the estimator engines 212. The estimation process then comes to an end.

The estimator 214 assesses performance of checksum and data transfer processes by consuming harvested metrics to compute an estimate of the duration to complete pending work, i.e., an estimated time to transfer the remaining data of a VM being migrated. The estimator 214 works on the core principle of looking at “effort invested to get the work done in recent past” to project “effort required to carry remaining work”. The “effort invested to get the work done in recent past” refers to a quantum of checksum and data transfer work done most recently in a specific time window, which can be used to calculate the “current rate of work being performed.” This rate can then be used to compute the time estimate to complete the pending work, which relates to the “effort required to carry remaining work.”

The “current rate of work being performed” can be computed as: current rate of work being performed = work done so far/ time taken to complete the work. The “pending work” or the remaining work for the transfer to complete can be computed as: pending work = total work - work done so far. With the computed “current rate of work being performed” and “pending work”, the remaining duration, which is the estimate of the duration to complete pending work, can be computed as: duration to complete pending work = (pending work) / (current rate of work being performed).

The “work done” described above can be deduced with a delta summation approach. Each metric sample contains following information: (1) the “data transferred” snapshot value at the current sampling time, i.e., the total amount of data transferred from the start of data transfer to the current sampling time, and (2) timestamp of the sampling time. For a time window of size n, where n is the number of samplings at different times, the delta summation approach involves computing the delta or difference between successive or adjacent “data transferred” snapshot values in the time window and then adding up the deltas for the “data transferred” snapshot values to derive a delta sum. This resulting delta sum is the “work done” for the time window. The time window can be determined using the timestamps in the metric samples. Thus, the “current rate of work being performed” can be computed by dividing the “work done” by the “time window”.

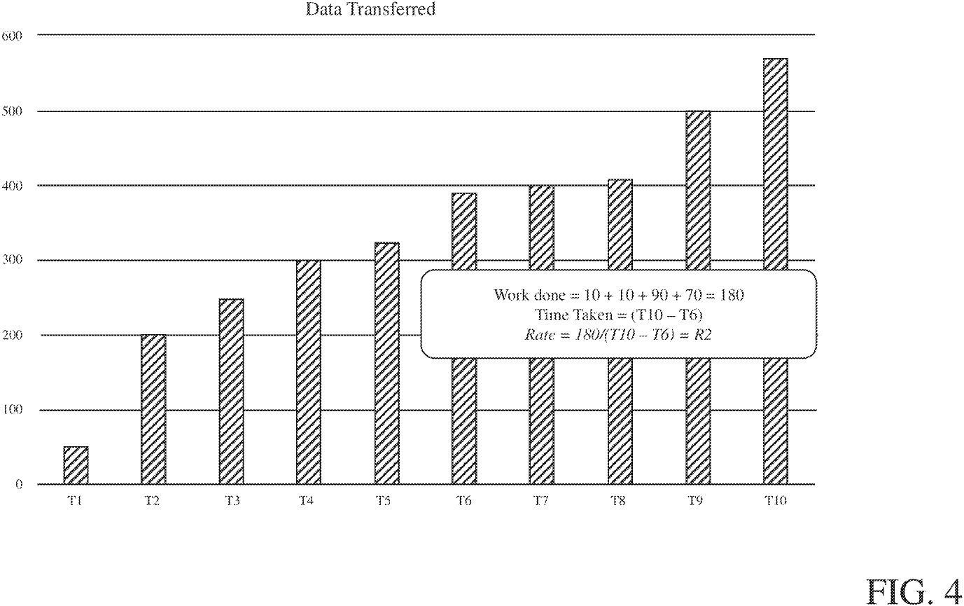

Calculating the “current rate of work being performed”, which is referred to herein as the “current data transfer rate”, in accordance with an embodiment of the invention is described using an example of “data transferred” snapshot values over time T1-T10, as illustrated by a bar graph shown in FIG. 4. As shown in the bar graph, the “data transferred” snapshot values over time T1-T10 are [40, 200, 250, 300, 330, 390, 400, 410, 500, 570]. For a window size of 5, at time T10, the “data transferred” snapshot values for times T6, T7, T8, T9 and T10, which correspond to [390, 400, 410, 500, 570], are used. The first delta between the “data transferred” snapshot values for times T6 and T7 is 400 minus 390, which is 10. The second delta between the “data transferred” snapshot values for times T7 and T8 is 410 minus 400, which is again 10. The third delta between the “data transferred” snapshot values for times T8 and T9 is 500 minus 410, which is 90. The fourth delta between the “data transferred” snapshot values for times T9 and T10 is 570 minus 500, which is 70. Thus, “work done” (using delta sum) = 10 + 10 + 90 + 80 = 180. The duration for this “work done” is time T10 minus time T6, and the rate of work is “work done” divided by duration or 180/ (T10 - T6), which is illustrated in FIG. 4 as R2.

For a window size of 5, at time T7, the “data transferred” snapshot values for times T3, T4, T5, T6 and T7, which correspond to [250, 300, 330, 390, 400], are used. Thus, (a) “work done” (using delta summation) = 50 + 30 + 60 + 10 = 150, (b) duration = (T7-T3), and (c) rate of work = 150/ (T7 - T3).

As illustrated above, there are multiple candidates, which can have overlapping time windows, for consideration to derive the “rate of work” or the “data transfer rate”. The trend seen in the most recent windows is likely to dominate the trend in the near future. However, care should be taken not to get biased due to transient abrupt anomaly.

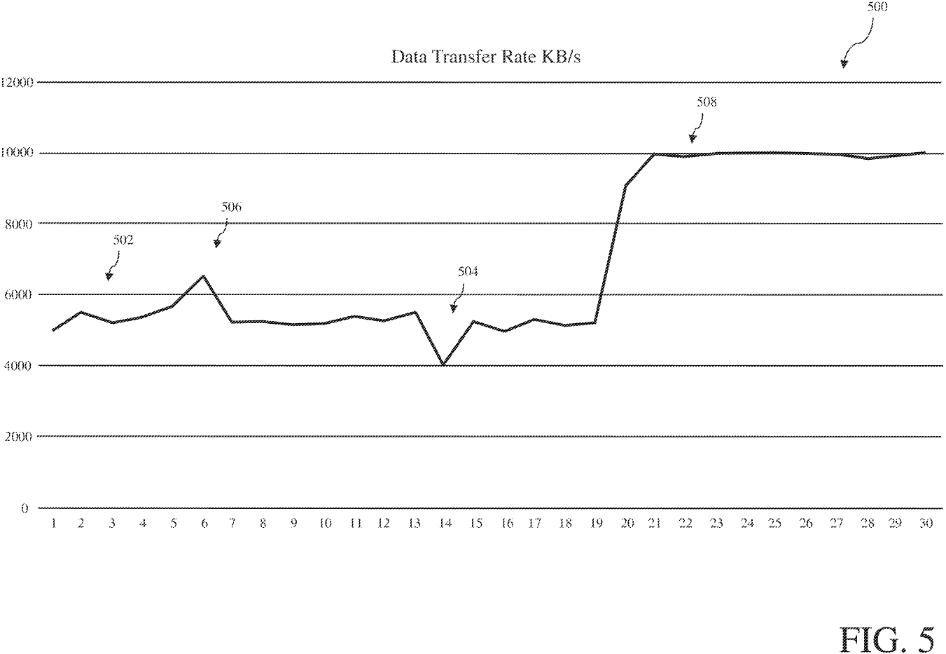

The “data transfer rate” metric can have different behaviors, as illustrated in FIG. 5, which shows a graph 500 of “data transfer rate” in kilobytes (KB) per second (s) over time. One of the possible behaviors is that the “data transfer rate” can be consistent and stable through the migration, as illustrated in a segment 502 of the “data transfer rate” graph 500. Another possible behavior is that the “data transfer rate” can have temporary dips, due to network fluctuations, etc., as illustrated in a segment 504 of the graph 500. Still another possible behavior is that the “data transfer rate” can have temporary peaks, due to network fluctuations, etc., as illustrated in a segment 506 of the graph 500. Another possible behavior is that the “data transfer rate” can have a sudden improvement in performance as more resource become available and continues in such state, as illustrated in a segment 508 of the graph 500, or have a reduced performance as more load is put on the system and the resources are constrained.

In order to ensure that the estimates are relatively stable with respect to the underlying system and converge to the real system state quickly, weighted moving average (WMA) is used by the estimator 214 to calculate the current data transfer rate. This weighted moving average rate is computed by the estimator 214 by considering “work done” over a window size of n, where n is the number of samples used to compute each rate for the weighted moving average rate. Using the duration of the window size, the “current rate of work” can be derived. The previous instance of “rate of work” is also remembered by the estimator 214, which was calculated over an overlapping time window just before the current “rate of work” calculation. The current “rate of work” (or “current rate”) and the previous “rate of work” (or “previous rate”) are then used by the estimator with a predefined factor “alpha”, which weighs the current and previous rates, to calculate the weighted MA data transfer rate as: MA data transfer rate = alpha * (current rate) + (1 - alpha) * (previous rate). Using this weighted rate, the duration to complete to pending work can be calculated for each of the VMs being migrated and the one takes the longest is chosen to be the final prediction.

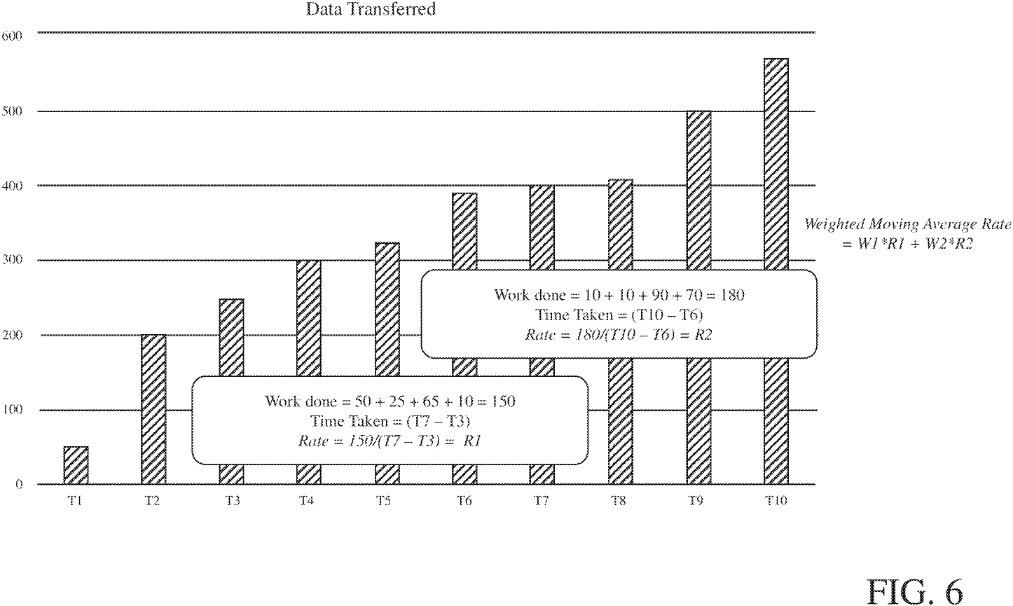

An example of a weighted MA data transfer rate is illustrated in FIG. 6, which shows the weighted MA data transfer rate of the rate of work R1 at time T7 and the rate of work R2 at time T10 using weights W1 and W2. Although data transfer rates from non-overlapping time windows may be used, overlapping time windows provide more stable results.

In some embodiments, the “alpha” value and “window size” can be adjusted based on VM characteristics and other parameters, thereby making the estimations even more reliable. As an example, the window size for small VMs (e.g., less than 50 gigabyte (GB)), medium VMs (e.g., less than 1 terabyte (TB)) and large VMs (e.g., greater than 1 TB) may be set at 5, 10 and 20, respectively.

It is noted here that relation between the “rate of work” and “estimated time to complete” (estimations) are such that the “rate of work” and estimations are inversely related, i.e., higher rate of work implies lower estimations and vice-versa. This relation is used to compare the behavior of (1) estimation using rate without moving average (EST), i.e., using the current system state, (2) estimation using MA rate with window size of 5 (EST-MA5), and estimation using WMA rates with fixed alpha value of 0.5 and window size of 5 (EST-WMA5) for the example of “data transfer rate” over time, which is shown as the graph 500 in FIG. 5.

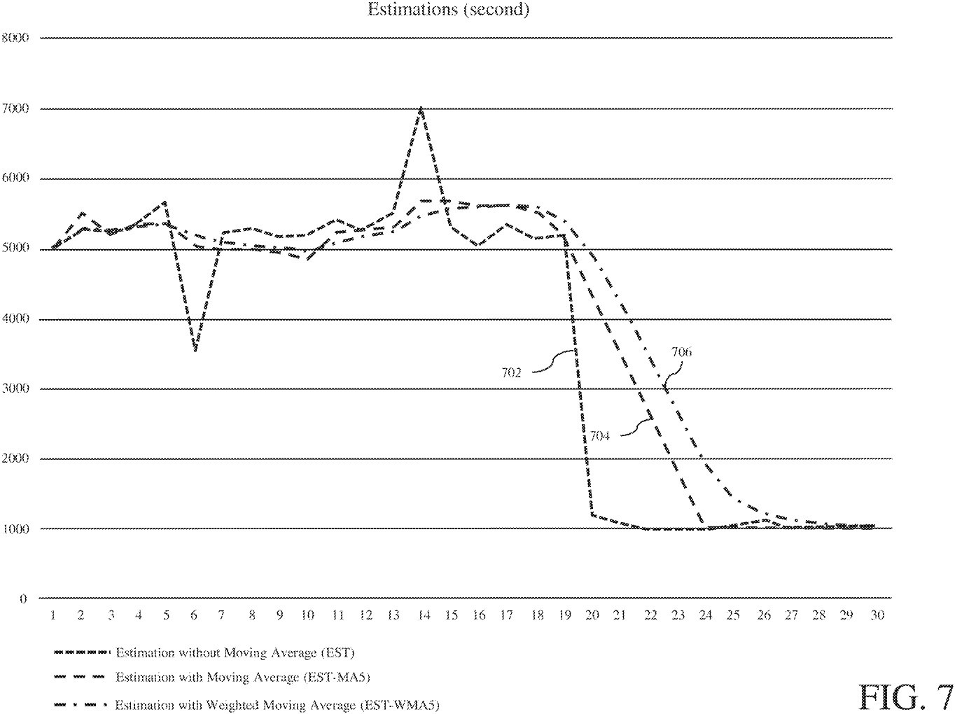

In the graph 500 of FIG. 5, from time T1 to time T5, the “data transfer rate” is stable, and hence, all the estimations are also stable from time T1 to T5, as illustrated in FIG. 7, which shows the three types of estimations as an EST line 702, an EST-MA5 line 704 and an EST-WMA5 line 706. At time T6, the “data transfer rate” has a momentary increase of about 15% (from 5650 KB/s to ~6500 KB/s), as shown in FIG. 5. Meanwhile, the estimation using rates without moving average (EST) follows the system behavior and the estimation at time T6 is ~15% lower than the previous value, the estimation using MA rates with window size of 5 (EST-MA5) fluctuates less than 1%, and the estimation using WMA rates with fixed alpha value of 0.5 and window size of 5 (EST-WMA5) fluctuate even lesser than the EST-MA5, as shown in FIG. 7.

At time T14, the “data transfer rate” has a momentary decrease of ~25%, as shown in FIG. 5. Meanwhile, the EST follows the trend and predicts a higher time to complete (about 20% higher than previous estimation), the estimation MA5 fluctuates less than 1%, and the EST-WMA5 fluctuates lesser than the EST-MA5, as shown in FIG. 7.

From time T21, the “data transfer rate” has an increase of about 25% and remains at about the new increased level, as shown in FIG. 5. Meanwhile, the EST follows the trend and instantly dips to reflect the new state, the EST-MA5 takes some time to converge (it converges at time T24) and fluctuates less than 1%, and the EST-WMA5 takes even longer and converges only at time T28, as shown in FIG. 7.

From the above observation, it is clear that the estimations using weighted moving average handle momentary fluctuations better than the estimations without using moving average (which follows the system behavior) and the estimations using moving average. However, the estimations using weighted moving average takes longer to converge to new system state, should it change.

While the weighted moving average stabilizes the estimations to ensure the momentary spikes/dips do not have a significant impact on the estimated values, the convergence to the real state of the system takes time. That is, if the data transfer rate values see a dip/peak and continues to stay in the new state, the estimations will take time to reflect this behavior.

In some embodiments, the alpha or the weight in the weighted moving average is further improved by the estimator 214 by apprising the estimation using moving average and the estimation using weighted moving average. The comparison of these estimations decides the alpha, thus acting as feedback and helping the estimation to converge to the real state of the system faster. Specifically, divergence of the estimation using moving average and the estimation using weighted moving average is used to adjust the alpha value. In an embodiment, if the absolute difference of the estimation using the moving average and the estimation using weighted moving average is greater than a predefined value, e.g., 20%, then alpha is increased by a step-up value, e.g., 0.1. The value of alpha may be capped at a set maximum value, e.g., 0.8. In addition, if (1) the absolute difference of the estimation using the moving average and the estimation using weighted moving average is not greater than the predefined value and (2) the value of alpha is greater than a set minimum value, e.g., 0.5, then alpha may be decreased by a step-down value, e.g., 0.1. Thus, the lower limit of alpha is the set minimum value.

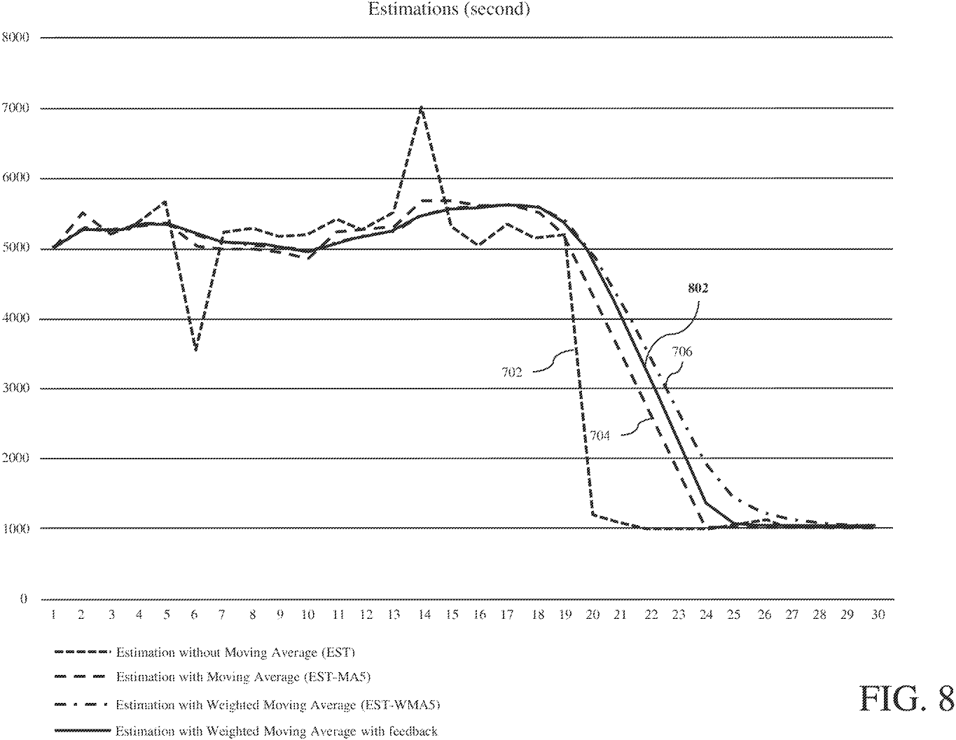

The behavior of the EST-WMA5 with feedback compared to the other estimations is illustrated in FIG. 8 as a line 802. The line 802 for the EST-WMA5 with feedback (EST-WMA5F) follows the line for the EST-WMA5 (without feedback) from time T1 to T20. However, at time T20, the line 802 for the EST-WMA5F begins to converge to the new system state when the EST-WMA5 diverges significantly (e.g., 20%) from the line for the EST-MA5. Thus, the EST-WMA5F (with feedback) converges to the new system state quicker than the EST-WMA5 (without feedback).

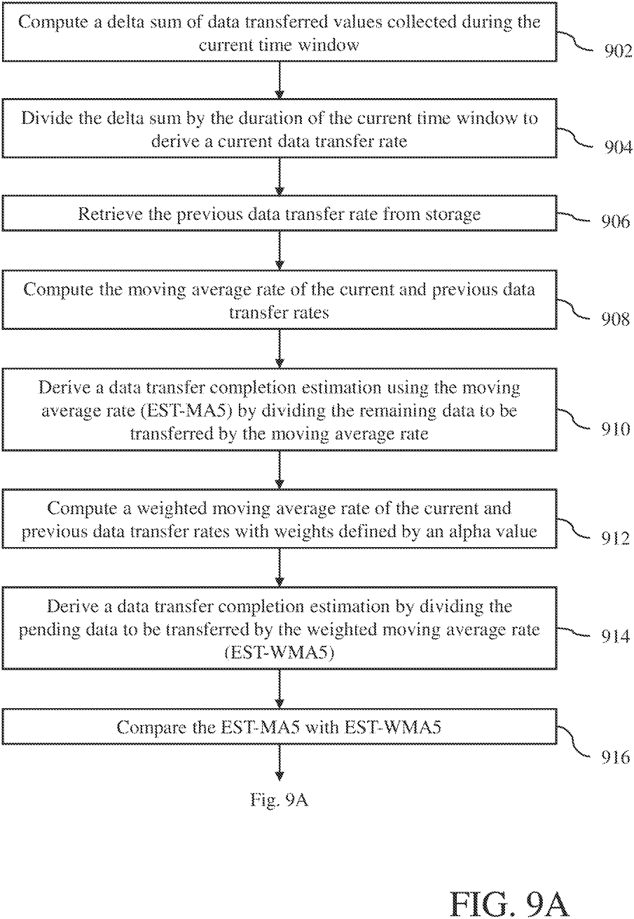

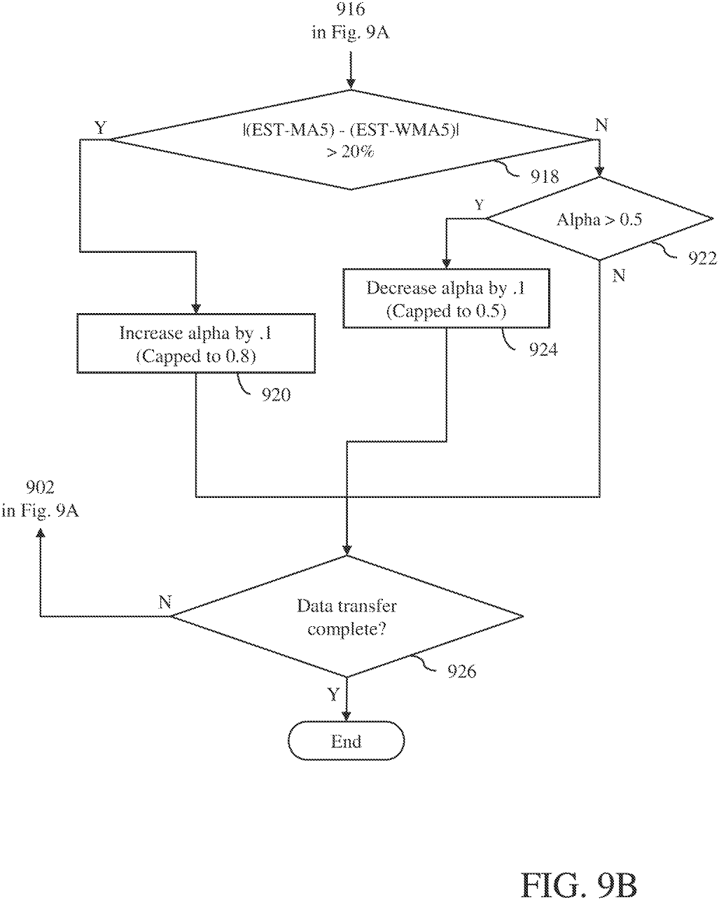

The process of computing a data transfer completion estimation for a VM by each of the estimators 214 in the estimation sub-system in accordance with an embodiment of the invention is described with reference to a flow diagram shown in FIGS. 9A and 9B. The process begins at step 902, where a delta sum of transferred data values collected during the current time window is computed by the estimator 214. The time window has a window size of five (5) collection times in this embodiment. However, as explained above, in other embodiments, the window size may be different than five (5) collection times.

Next, at step 904, the delta sum is divided by the duration of the current time window to derive a current data transfer rate by the estimator 214. The duration of the current time window may be computed using timestamps of data transfer metrics collected at the source computer network and/or the target computer network. The computed current data transfer rate may be stored in storage, which may be any persistent storage accessible by the estimator 214.

Next, at step 906, the previous data transfer rate is retrieved from the storage estimator by the estimator 214. Next, at step 908, the moving average rate of the current and previous data transfer rates is computed by the estimator 214.

Next, at step 910, a data transfer completion estimation using the moving average rate (EST-MA5) is derived by the estimator 214. The EST-MA5 is computed by dividing the current pending work, i.e., amount of remaining data to be copied over from the source computer network to the target computer network, by the moving average rate of the current and previous data transfer rates. The computed EST-MA5 is stored in storage, which may be the same persistent storage used for the current transfer or any other persistent storage accessible by the estimator 214.

Next, at step 912, a weighted moving average rate of the current and previous data transfer rates is computed with weights defined by an alpha value by the estimator 214. In an embodiment, the weight of the current data transfer rate is the alpha value and the weight of the previous data transfer rate is one minus the alpha value.

Next, at step 914, a data transfer completion estimation using the weighted moving average (EST-WMA5) is derived by the estimator 214. The EST-WMA5 is computed by dividing the current pending work, i.e., amount of remaining data to be copied over from the source computer network to the target computer network, by the weighted moving average rate. The computed EST-WMA5 is stored in storage, which may be the same persistent storage used for the current data transfer rate or any other persistent storage accessible by the estimator 214.

Next, at step 916, the EST-MA5 is compared with the EST-WMA5 by the estimator 214. Next, at step 918, a determination is made by the estimator 214 whether the absolute value of the difference between the EST-MA5 and the EST-WMA5 is greater than a threshold value, which can be a number or a percentage. In this embodiment, the threshold value is twenty (20) percent, so the determination is made whether the absolute value of the difference between the EST-MA5 and the EST-WMA5 is greater than twenty (20) percent.

If the absolute value of the difference between the EST-MA5 and the EST-WMA5 is greater than the predefined value, then the process proceeds to step 920, where the alpha value is increased by a step-up value by the estimator 214. In this embodiment, the step-up value is set at 0.1. Thus, if the current value of alpha is 0.5, then the alpha value is increased to 0.6. In other embodiments, the step-up value may be a value other than 0.1. However, the alpha value is capped at a maximum value. In this embodiment, the maximum value for the alpha value is set at 0.8. Thus, if the current alpha value is 0.8, then the alpha value is not increased since the maximum value has been reached. In other embodiments, the maximum value may be a value other than 0.8, but not greater than 1.

Next, at step 926, a determination is made by the estimator 214 whether the data transfer has been completed. If yes, then the process comes to an end. If no, then the process proceeds back to step 902 to compute the next data transfer completion estimation (i.e., next EST-WMA5) using the latest alpha value, which may have been increased or decreased, after a set time interval, which can be few minutes, few hours or few days.

Turning back to step 918, if the absolute value of the difference between the EST-MA5 and the EST-WMA5 is not greater than the threshold value, then the process proceeds to step 922, where a determination is made by the estimator 214 whether the alpha value is greater than a minimum value. In this embodiment, the minimum value for the alpha value is set at 0.5. In other embodiments, the minimum value may be a value other than 0.5, but not less than 0.

If the alpha value is greater than the minimum value, then the process proceeds to step 924, where the alpha value is decreased by a step-down value by the estimator 214. Thus, the alpha value is capped at the minimum value. In this embodiment, the step-down value is set at 0.1. Thus, if the current value of alpha is 0.6, then the alpha value is decreased to 0.5. In other embodiments, the step-down value may be a value other than 0.1. However, the alpha value is lower limit capped at the minimum value. Thus, if the current value of the alpha value is 0.5, then the alpha value is not decreased since the alpha value is currently at the minimum value.

The process then proceeds to step 926 to determine whether the data transfer has been completed. If yes, then the process comes to an end. If no, then the process proceeds back to step 902 to compute the next data transfer completion estimation (i.e., next EST-WMA5) using the latest alpha value, which may have been increased or decreased, after the set time interval, which can be few minutes, few hours or few days.

Turning back to step 922, if the alpha value is not greater than the minimum value, the process proceeds directly to step 926, where a determination is made by the estimator 214 whether the data transfer has been completed. If yes, then the process comes to an end. If no, then the process proceeds back to step 902 to compute the next data transfer completion estimation (i.e., next EST-WMA5) using the latest alpha value, which may have been increased or decreased, after the set time interval.

As explained above, each estimator 214 may handle transfers for multiple VMs (which may be clubbed together as migration/mobility group), and thus, each estimate may compute more than one EST-WMA5 for the VMs that are currently in the replication phase of the migration process, i.e., VM data is currently being transferred. The longest estimation duration pertaining to a VM in the group is treated as estimation for the group.

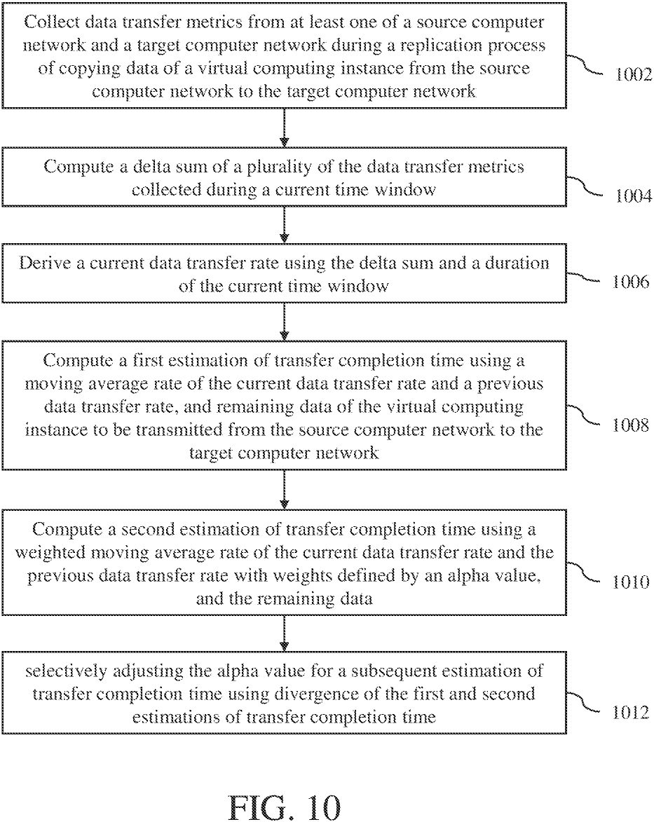

A computer-implemented method for migrating virtual computing instances from source computer networks to target computer networks in accordance with an embodiment of the invention is described with reference to a process flow diagram of FIG. 10. At block 1002, data transfer metrics are collected from at least one of a source computer network and a target computer network during a replication process of copying data of a virtual computing instance from the source computer network to the target computer network. At block 1004, a delta sum of a plurality of the data transfer metrics collected during a current time window is computed. At block 1006, a current data transfer rate is derived using the delta sum and a duration of the current time window. At block 1008, a first estimation of transfer completion time is computed using a moving average rate of the current data transfer rate and a previous data transfer rate, and remaining data of the virtual computing instance to be transferred from the source computer network to the target computer network. At block 1010, a second estimation of transfer completion time is computed using a weighted moving average rate of the current data transfer rate and the previous data transfer rate with weights defined by an alpha value, and the remaining data of the virtual computing instance to be transmitted from the source computer network to the target computer network. At block 1012, the alpha value for a subsequent estimation of transfer completion time is selectively adjusted using divergence of the first and second estimations of transfer completion time.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for migrating virtual computing instances from source computer networks to target computer networks, the method comprising:
collecting data transfer metrics from at least one of a source computer network and a target computer network during a replication process of copying data of a virtual computing instance from the source computer network to the target computer network;
computing a delta sum of a plurality of the data transfer metrics collected during a current time window;
deriving a current data transfer rate using the delta sum and a duration of the current time window;
computing a first estimation of transfer completion time using a moving average rate of the current data transfer rate and a previous data transfer rate, and remaining data of the virtual computing instance to be transmitted from the source computer network to the target computer network;
computing a second estimation of transfer completion time using a weighted moving average rate of the current data transfer rate and the previous data transfer rate with weights defined by an alpha value, and the remaining data; and
selectively adjusting the alpha value for a subsequent estimation of transfer completion time using divergence of the first and second estimations of transfer completion time.

2. The method of claim 1, wherein computing the delta sum includes summing differences of data transferred values collected at adjacent sampling times in the current time window.

3. The method of claim 1, wherein deriving the current data transfer rate includes dividing the delta sum by a duration of the current time window.

4. The method of claim 1, wherein computing the first estimation of transfer completion time includes dividing the remaining data to be transferred by the moving average rate of the current and previous data transfer rates.

5. The method of claim 1, wherein computing the second estimation of transfer completion time includes dividing the remaining data to be transferred by the weighted moving average rate of the current and previous data transfer rates.

6. The method of claim 5, wherein a weight for the current data transfer rate is the alpha value and a weight for the previous data transfer rate is one minus the alpha value.

7. The method of claim 1, wherein selectively adjusting the alpha value includes increasing the alpha value by a step-up value when the absolute value of the difference between the first and second estimations of transfer completion time is greater than a threshold value.

8. The method of claim 1, wherein selectively adjusting the alpha value includes decreasing the alpha value by a step-down value when the absolute value of the difference between the first and second estimations of transfer completion time is not greater than a threshold value and the alpha value is greater than a minimum value.

9. A non-transitory computer-readable storage medium containing program instructions for migrating virtual computing instances from source computer networks to target computer networks, wherein execution of the program instructions by one or more processors causes the one or more processors to perform steps comprising:
collecting data transfer metrics from at least one of a source computer network and a target computer network during a replication process of copying data of a virtual computing instance from the source computer network to the target computer network;
computing a delta sum of a plurality of the data transfer metrics collected during a current time window;
deriving a current data transfer rate using the delta sum and a duration of the current time window;
computing a first estimation of transfer completion time using a moving average rate of the current data transfer rate and a previous data transfer rate, and remaining data of the virtual computing instance to be transmitted from the source computer network to the target computer network;
computing a second estimation of transfer completion time using a weighted moving average rate of the current data transfer rate and the previous data transfer rate with weights defined by an alpha value, and the remaining data; and
selectively adjusting the alpha value for a subsequent estimation of transfer completion time using divergence of the first and second estimations of transfer completion time.

10. The non-transitory computer-readable storage medium of claim 9, wherein computing the delta sum includes summing differences of data transferred values collected at adjacent sampling times in the current time window.

11. The non-transitory computer-readable storage medium of claim 9, wherein deriving the current data transfer rate includes dividing the delta sum by a duration of the current time window.

12. The non-transitory computer-readable storage medium of claim 9, wherein computing the first estimation of transfer completion time includes dividing the remaining data to be transferred by the moving average rate of the current and previous data transfer rates.

13. The non-transitory computer-readable storage medium of claim 9, wherein computing the second estimation of transfer completion time includes dividing the remaining data to be transferred by the weighted moving average rate of the current and previous data transfer rates.

14. The non-transitory computer-readable storage medium of claim 13, wherein a weight for the current data transfer rate is the alpha value and a weight for the previous data transfer rate is one minus the alpha value.

15. The non-transitory computer-readable storage medium of claim 9, wherein selectively adjusting the alpha value includes increasing the alpha value by a step-up value when the absolute value of the difference between the first and second estimations of transfer completion time is greater than a threshold value.

16. The non-transitory computer-readable storage medium of claim 9, wherein selectively adjusting the alpha value includes decreasing the alpha value by a step-down value when the absolute value of the difference between the first and second estimations of transfer completion time is not greater than a threshold value and the alpha value is greater than a minimum value.

17. A system comprising:
memory; and
one or more processors configured to:
collect data transfer metrics from at least one of a source computer network and a target computer network during a replication process of copying data of a virtual computing instance from the source computer network to the target computer network;
compute a delta sum of a plurality of the data transfer metrics collected during a current time window;
derive a current data transfer rate using the delta sum and a duration of the current time window;
compute a first estimation of transfer completion time using a moving average rate of the current data transfer rate and a previous data transfer rate, and remaining data of the virtual computing instance to be transmitted from the source computer network to the target computer network;
compute a second estimation of transfer completion time using a weighted moving average rate of the current data transfer rate and the previous data transfer rate with weights defined by an alpha value, and the remaining data; and
selectively adjust the alpha value for a subsequent estimation of transfer completion time using divergence of the first and second estimations of transfer completion time.

18. The system of claim 17, wherein the one or more processors are configured to divide the remaining data to be transferred by the moving average rate of the current and previous data transfer rates to compute the first estimation of transfer completion time.

19. The system of claim 17, wherein the one or more processors are configured to divide the remaining data to be transferred by the weighted moving average rate of the current and previous data transfer rates to compute the second estimation of transfer completion time.

20. The system of claim 19, wherein a weight for the current data transfer rate is the alpha value and a weight for the previous data transfer rate is one minus the alpha value.
